(19) United States
(12) Patent Application Publication
(10) Pub. No.: US 2009/0139801 A1
(43) Pub. Date: Jun. 4, 2009

(54) Forklift Hitch Attachment Device

(76) Inventor: Delton Friesen, Chandler, AZ (US)

Correspondence Address: VENABLE, CAMPILLO, LOGAN & MEANEY, P.C., 1938 E. OSBORN RD, PHOENIX, AZ, 85016-7234, US

(21) Appl. No.: 11/947,812

(22) Filed: Nov. 30, 2007

(51) Int. Cl. B66F 9/12

(52) U.S. Cl. 187/237

(57) ABSTRACT

The present invention is a device that easily attaches a forklift hitch to a forklift beam. The device is removable from the forklift beam and does not require alteration to the forklift beam. The invention includes a cam, a cam assembly, a lock assembly, and a tensioner.

### FIELD OF THE INVENTION

The present invention relates generally to the field of transportation devices. Specifically, the present invention is a device designed to attach a mobile trailer or cart to a forklift vehicle.

### BACKGROUND OF THE INVENTION

The standard method of transporting small to medium-sized trailers is with the use of a vehicle such as an automobile or truck. The vehicle generally has a standard steel trailer hitch secured to its rear portion. The trailer generally contains a device capable of receiving the trailer hitch and securing it, such that a motorized vehicle may pull the trailer to its destination.

Due to the fact that larger trailers are generally heavier, they typically require a motorized vehicle using this method to transport the trailer. However, for smaller trailers, such as those that transport jet skis or other small loads, the use of a motorized vehicle may not be necessary.

Trailers, dollies, and carts are frequently employed in warehouses to transport boxes and containers of equipment and goods. One machine that is commonly used in warehouses to move boxes and crates is a forklift vehicle. It is therefore highly desirable to invent a device that could attach the cart, or trailer to the forklift vehicle. This would increase the versatility of forklift vehicles and reduce the amount of equipment needed in a warehouse.

U.S. Pat. No. 6,390,489 issued to Friesen discloses a hitch that attaches a trailer or cart to a forklift. The patent discloses that the forklift beam is attached to the disclosed forklift hitch by drilling a hole into the forklift beam and through the center of the forklift hitch such that a pin fits through the forklift beam and the forklift hitch thereby removably securing the device to the forklift. However, it is desirable to provide additional stability to the device attached to the hitch and often requires that the forklift beam be retrofitted by drilling a hole through the forklift beam for the attachment to the forklift hitch.

As such, it is desirable to be able to couple a forklift hitch to a forklift beam without having to retrofit the existing beam. The present invention allows a user to secure a forklift hitch to a forklift beam without altering the original forklift beam.

### SUMMARY OF THE INVENTION

The present invention is a device for attaching a forklift hitch to a forklift beam. A forklift is comprised of two parallel beams that are raised and lowered in unison to raise and lower a crate or package supported by the two parallel beams. These two parallel beams form a single lifting platform. The forklift hitch is secured to one of these two beams using the device. One feature of the present invention is that it is removable from the single beam of the forklift without altering the forklift beam.

The forklift hitch attachment comprises a cam assembly with a first end and a second end; a cam; a lock assembly having an open position and a closed position; a forklift hitch with a cam opening and a shaft; and a tensioner. The cam is rotably coupled to the first end of the cam assembly and to the forklift hitch. The lock assembly is rotably coupled to the second end of the cam assembly. The tensioner is coupled to the lock assembly and to the forklift hitch. When the lock assembly is in the open position, the tensioner is movable and the cam moves in and out of the cam opening allowing a forklift beam to be inserted into the shaft on the forklift hitch. When the lock assembly is rotated to a closed position, the tensioner is taut and the cam assembly and the cam rotate wherein the cam engages the forklift beam through the cam opening such that the cam secures the forklift beam to the forklift hitch.

The primary object of this invention is to provide a device that will secure a forklift hitch to a forklift beam.

A further object of this invention is to provide a device that will secure a forklift hitch to a forklift beam with simplicity and ease of effort.

A still further object of the invention is to provide a device that will secure a forklift hitch to a forklift beam with out modification to the forklift.

The novel features that are considered characteristic of the invention are set forth with particularity in the appended claims. The invention itself, however, both as to its structure and its operation together with the additional object and advantages thereof will best be understood from the following description of the preferred embodiment of the dual seal dry snorkel when read in conjunction with the accompanying drawings. Unless specifically noted, it is intended that the words and phrases in the specification and claims be given the ordinary and accustomed meaning to those of ordinary skill in the applicable art or arts. If any other meaning is intended, the specification will specifically state that a special meaning is being applied to a word or phrase. Likewise, the use of the words “function” or “means” in the Description of Preferred Embodiments is not intended to indicate a desire to invoke the special provision of 35 U.S.C. §112, paragraph 6 to define the invention. To the contrary, if the provisions of 35 U.S.C. §112, paragraph 6 are sought to be invoked to define the invention(s), the claims will specifically state the phrases “means for” or “step for” and a function, without also reciting in such phrases any structure, material, or act in support of the function.

Moreover, even if the provisions of 35 U.S.C. §112, paragraph 6 are invoked to define the inventions, it is intended that the inventions not be limited only to the specific structure, material or acts that are described in the preferred embodiments, but in addition, include any and all structures, materials or acts that perform the claimed function, along with any and all known or later developed equivalent structures, materials, or acts for performing the claimed function.

### BRIEF DESCRIPTION OF THE DRAWINGS

FIG. 1 shows a perspective view of the preferred embodiment of the invention.

FIG. 2 shows a front end view of the preferred embodiment of the invention.

FIG. 3 shows a rear end view of the preferred embodiment of the invention.

FIG. 4 shows a first side view of the preferred embodiment of the invention.

FIG. 5 shows a second side view of the preferred embodiment of the invention.

FIG. 6 shows a cross section of the first side view of the preferred embodiment of the invention.

FIG. 7 shows a bottom view of the preferred embodiment of the invention.

FIG. 8 shows a top view of the preferred embodiment of the invention with the lock assembly in an open position.

FIG. 9 shows a top view of the preferred embodiment of the invention with the lock assembly rotating to a closed position.

FIG. 10 shows a top view of the preferred embodiment of the present invention with the lock assembly in an open position and the forklift beam inserted into the shaft of the forklift hitch.

FIG. 11 shows a top view of the preferred embodiment of the present invention with the lock assembly rotating into a closed position and the cam engaging the forklift beam that is located in the shaft of the forklift hitch.

### DESCRIPTION OF PREFERRED EMBODIMENTS

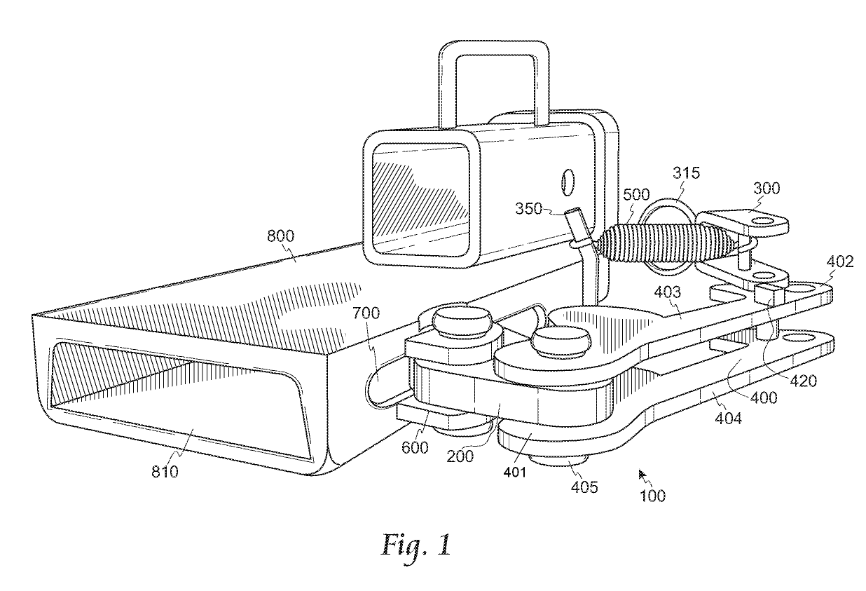

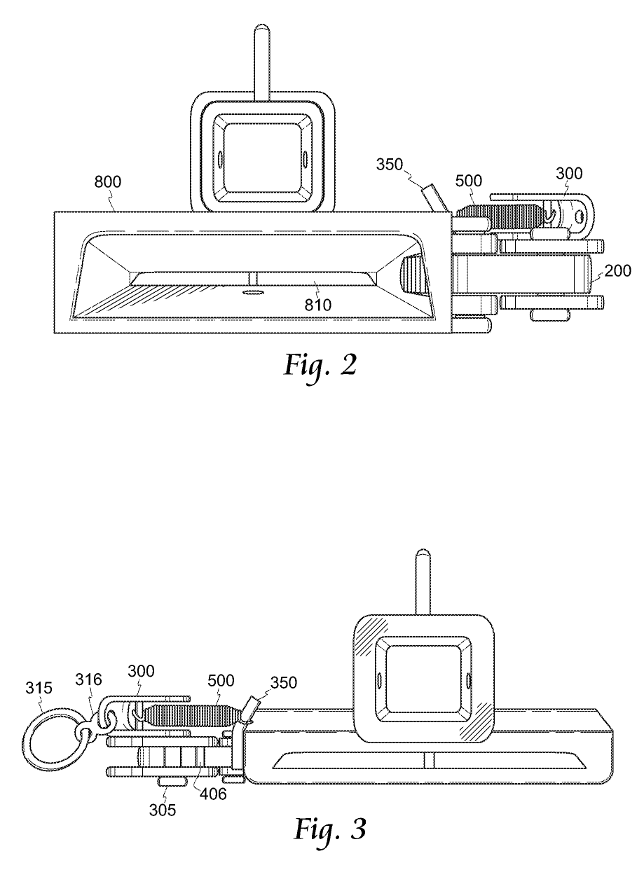

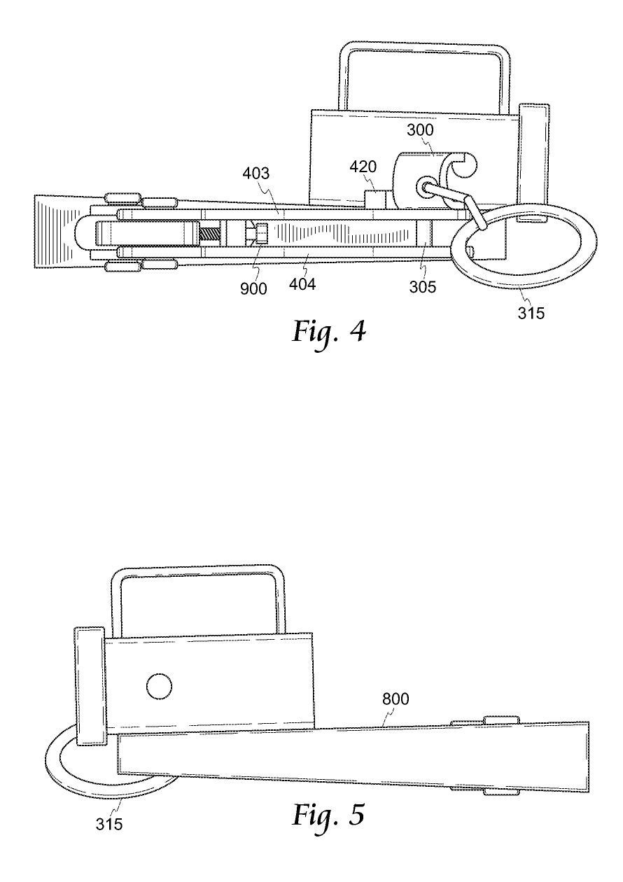

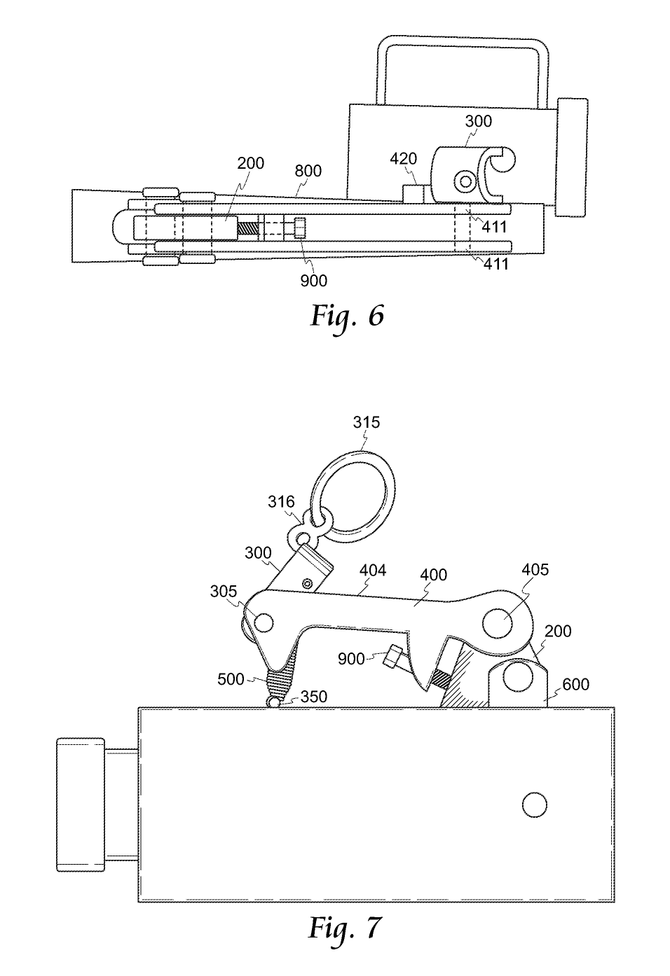

FIG. 1 shows the preferred embodiment of the forklift hitch attachment device 100. Specifically, the forklift hitch attachment device 100 is comprised of a cam 200, a lock assembly 300, a cam assembly 400, a tensioner 500, a forklift hitch coupler 600, and a cam opening 700. These elements combined together create the preferred embodiment of the forklift hitch attachment device 100.

Preferably, the cam assembly 400 has a first end 401 and a second end 402 and is an elongated piece that is comprised of a top plate 403 and a bottom plate 404 that are parallel and are coupled together on each end. In the preferred embodiment, the cam assembly 400 is made of metal. As shown in FIG. 1, at the first end 401 of the cam assembly 400, the cam 200 is partially inserted between the top plate 403 and the bottom plate 404, and a cam assembly fastener 405 is inserted through the top plate 403, bottom plate 404, and cam 200 such that the cam 200 and cam assembly 400 are coupled together and can rotate about an axis of the cam 200. The top plate 403 and the bottom plate 404 of the cam assembly 400 are coupled together at the second end 402 of the cam assembly 400 with a pin 406 as shown in FIG. 3.

Also coupled to the second end 402 of the cam assembly 400 is the lock assembly 300. Preferably, as seen in FIGS. 3 and 7, the lock assembly 300 is a U-shaped piece of metal that rotates around a fastener 305 that couples the lock assembly 300 to the cam assembly 400. In the preferred embodiment, the fastener 305 is a nut and bolt that is inserted into a hole 306 on the lock assembly 300 and a hole 411 on the cam assembly 400. Additionally, it is preferred that the lock assembly 300 includes a ring handle 315 that allows the user to safely operate the device without increased risk of injury to the hand. The ring handle 315 is coupled to the lock assembly 300 with an S-hook 316.

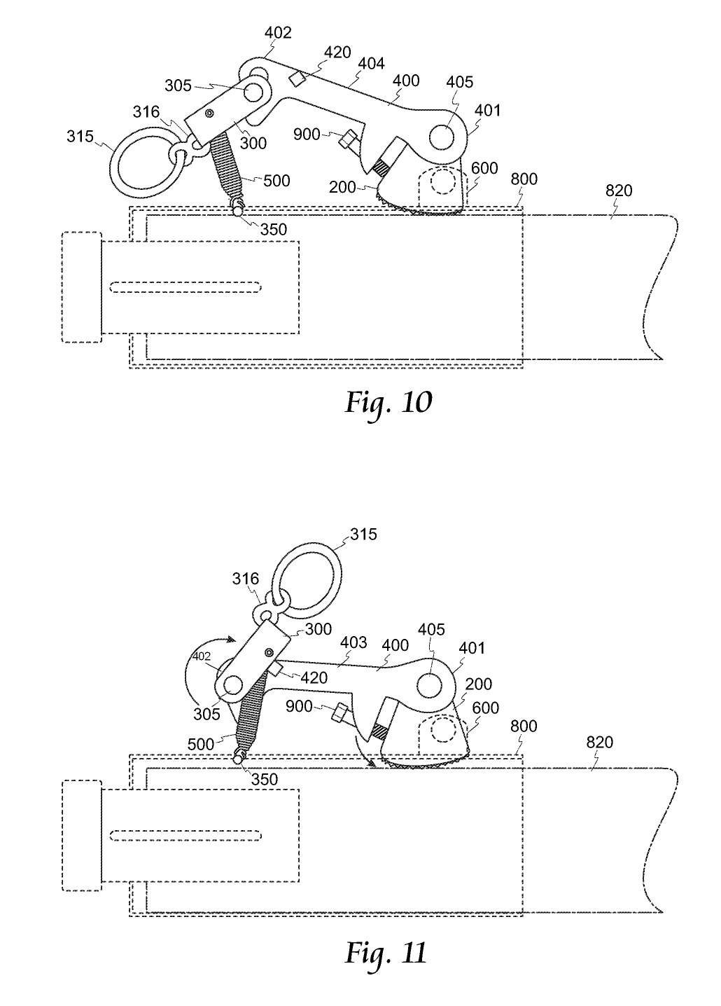

In the preferred embodiment of the invention, the cam 200 is able to be partially inserted into the shaft 810 of the forklift hitch 800 through the cam opening 700 as shown in FIG. 1. When the forklift beam 820, as shown in FIGS. 10 and 11, is inserted into the shaft 810 of the forklift hitch 800, the cam 200 engages the forklift beam 820 through the cam opening 700. It is preferred that the cam 200 is a gripping cam 200 that has teeth on one edge such that the teeth aid in securing the forklift beam 820 inside the shaft 810 of the forklift hitch 800. Further, it is preferred that the gripping cam 200 is made of a material that is harder than the forklift beam 820 so that when force is applied to the gripping cam 200 the friction created between the gripping cam 200 and the forklift beam 820 holds the forklift beam 820 in place.

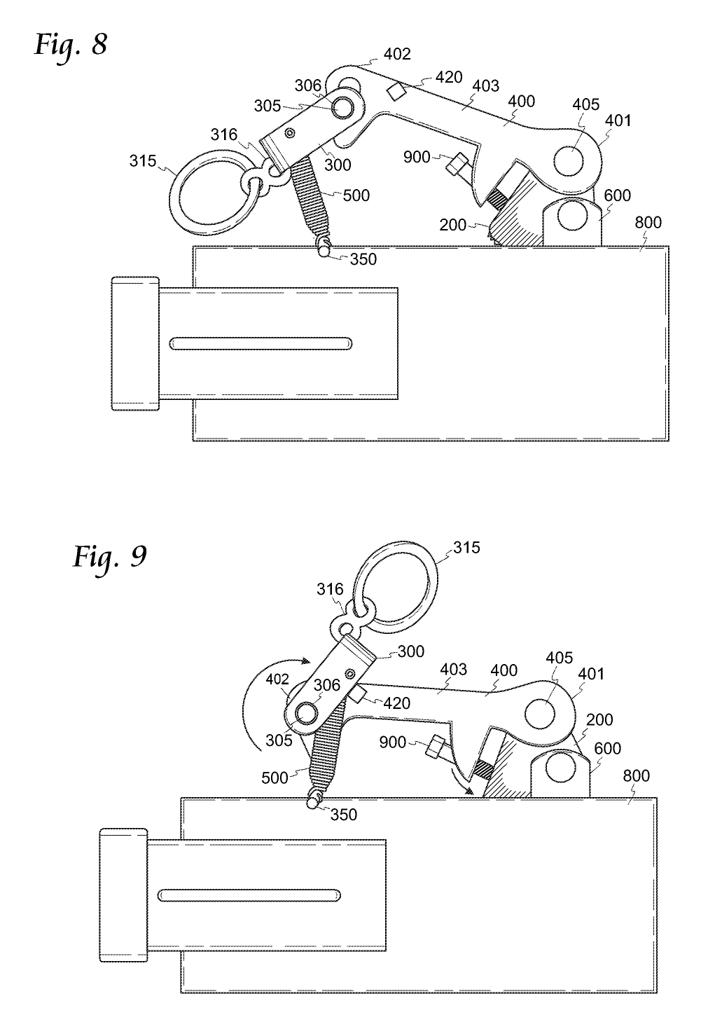

Further, a tensioner 500 is coupled to the lock assembly 300 and to a pin 350 that attaches to the forklift hitch 800. It is preferred that the tensioner 500 is a spring 500 as shown in all of the FIGS. As the lock assembly 300 is rotated to a closed position, as shown in FIGS. 9 and 11, the cam 200 also rotates and engages the forklift beam 820 through the cam opening 700 as shown in FIG. 11. The tensioner 500 then becomes taut and provides constant force to the cam 200 such that, as stated above, the cam 200 secures the forklift beam 820 inside of the shaft 810 of the forklift hitch 800. When the lock assembly 300 is then rotated back into the open position, the cam 200 disengages from the forklift beam 820 and the tensioner 500 is movable.

In the preferred embodiment of the invention, the cam assembly 400 includes an over center stop 420. The over center stop 420 is located near the second end 402 of the cam assembly 400. When the lock assembly 300 is rotated into the closed position, the over center stop 420 prevents the lock assembly 300 from over rotating by providing an impediment to the lock assembly's 300 continued motion. The over center stop 420 is preferably a piece of metal that is an integral part of the cam assembly 400.

To allow for slight variances in the dimensions of forklift beams 820, it is preferred that the forklift hitch attachment 100 include an adjustment device 900 such as a screw. In the preferred embodiment, the adjustment device 900 is inserted through a hole in the cam assembly 400 and comes in contact with the cam 200. The adjustment device 900 can be tightened or released to increase or lessen the pressure that the cam 200 exerts depending on the dimensions of the forklift beam 820. The adjustment device 900 is tuned once the lock assembly 300 is in the closed position.

The preferred embodiment of the invention is described in the Description of Preferred Embodiments. While these descriptions directly describe the one embodiment, it is understood that those skilled in the art may conceive modifications and/or variations to the specific embodiments shown and described herein. Any such modifications or variations that fall within the purview of this description are intended to be included therein as well. Unless specifically noted, it is the intention of the inventor that the words and phrases in the specification and claims be given the ordinary and accustomed meanings to those of ordinary skill in the applicable art(s). The foregoing description of a preferred embodiment and best mode of the invention known to the applicant at the time of filing the application has been presented and is intended for the purposes of illustration and description. It is not intended to be exhaustive or to limit the invention to the precise form disclosed, and many modifications and variations are possible in the light of the above teachings. The embodiment was chosen and described in order to best explain the principles of the invention and its practical application and to enable others skilled in the art to best utilize the invention in various embodiments and with various modifications as are suited to the particular use contemplated.

What is claimed is:

1. A device for attaching a forklift beam to a forklift hitch wherein said device is comprised of:
A. a cam assembly, said cam assembly further comprising:
i. a first end; and
ii. a second end;
B. a cam;
C. a lock assembly;
D. said forklift hitch further comprising:
i. a cam opening; and
ii. a shaft;
E. a tensioner;
F. the cam, wherein said cam is rotatably coupled to said first end of said cam assembly and to said forklift hitch;
G. the lock assembly, wherein said lock assembly is rotatably coupled to said second end of said cam assembly;
H. the tensioner, wherein said tensioner is coupled to said lock assembly and to said forklift hitch;
I. the lock assembly, wherein when said lock assembly is in an open position, a forklift beam may be inserted into said shaft; and
J. the lock assembly, wherein when said lock assembly is rotated to a closed position, said cam engages said forklift beam through said cam opening and said tensioner becomes taut such that said cam secures said forklift beam.

2. The device of claim 1 wherein said cam further comprises a plurality of teeth for gripping said forklift beam.

3. The device of claim 1 wherein said lock assembly further comprises a handle such that said lock assembly can be maneuvered into said closed position.

4. The device of claim 1 wherein said tensioner is a spring.

5. The device of claim 1 further comprising an over center stop such that when said lock assembly engages said over center stop, said lock assembly becomes stationary.

6. The device of claim 1 wherein said cam assembly further comprises an adjustment device wherein said adjustment device is in contact with said cam such that when said cam engages said forklift beam, said adjustment device can be attuned to vary the position of said cam in said cam opening.

7. A method for attaching a forklift beam to a forklift hitch comprising the following steps:
A. rotatably coupling a cam to a first end of a cam assembly;
B. rotatably coupling a lock assembly to a second end of said cam assembly;
C. coupling a tensioner to said lock assembly and to said forklift hitch;
D. coupling said cam to said forklift hitch such that said cam is inserted into a shaft on said forklift hitch through a cam opening;
E. inserting a forklift beam into said shaft on said forklift hitch when said lock assembly is in an open position; and
F. rotating said lock assembly to a closed position such said cam engages said forklift beam such that said forklift beam is secured by said cam through said cam opening and said tensioner becomes taut such that said cam secures said forklift beam.

8. The method of claim 7 wherein said cam further comprises a plurality of teeth for gripping said forklift beam.

9. The method of claim 7 wherein said lock assembly further comprises a handle such that said lock assembly can be maneuvered into said closed position.

10. The method of claim 7 wherein said tensioner is a spring.

11. The method of claim 7 further comprising the step of rotating said lock assembly until said lock assembly engages an over center stop such that said lock assembly becomes stationary.

12. The method of claim 7 wherein said cam assembly further comprises an adjustment device wherein said adjustment device is in contact with said cam such that when said cam engages said forklift beam, said adjustment device can be attuned to vary the position of said cam in said cam opening.
